(19) United States
(12) Patent Application Publication
(10) Pub. No.: US 2006/0187460 A1
(43) Pub. Date: Aug. 24, 2006

(54) Method for measuring the surface plasmon resonance

(75) Inventor: Hirohiko Tsuzuki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/354,839

(22) Filed: Feb. 16, 2006

(30) Foreign Application Priority Data
Feb. 18, 2005 (JP) 043209/2005

(51) Int. Cl. G01N 21/55

(52) U.S. Cl. 356/445

(57) ABSTRACT

It is an object of the present invention to provide a method for obtaining a chromatogram using the SPR analysis method. The present invention provides a method for measuring the change in the surface plasmon resonance by using a surface plasmon resonance measurement device which comprises a metal film, a light source for generating a light beam, an optical system for allowing such a light beam to enter the interface of the metal film so that total reflection conditions can be obtained at the interface thereof and so that various incidence angles can be included, a flow channel system comprising a cell formed on said metal film, and a light-detecting means for detecting the state of surface plasmon resonance by measuring the intensity of the light beam totally reflected at said interface, and exchanging a liquid contained in the flow channel system; wherein the measurement is carried out by supplying a liquid at a liquid amount such that the absolute amount of molecules adsorbed on the metal film surface is lower than the saturated adsorption amount of said molecules on said metal film surface.

### TECHNICAL FIELD

The present invention relates to a method for measuring the surface plasmon resonance.

### BACKGROUND ART

Recently, a large number of measurements using intermolecular interactions such as immune responses are being carried out in clinical tests, etc. However, since conventional methods require complicated operations or labeling substances, several techniques are used that are capable of detecting the change in the binding amount of a test substance with high sensitivity without using such labeling substances. Examples of such a technique may include a surface plasmon resonance (SPR) measurement technique, a quartz crystal microbalance (QCM) measurement technique, and a measurement technique of using functional surfaces ranging from gold colloid particles to ultra-fine particles. The SPR measurement technique is a method of measuring changes in the refractive index near an organic functional film attached to the metal film of a chip by measuring a peak shift in the wavelength of reflected light, or changes in amounts of reflected light in a certain wavelength, so as to detect adsorption and desorption occurring near the surface. The QCM measurement technique is a technique of detecting adsorbed or desorbed mass at the ng level, using a change in frequency of a crystal due to adsorption or desorption of a substance on gold electrodes of a quartz crystal (device). In addition, the ultra-fine particle surface (nm level) of gold is functionalized, and physiologically active substances are immobilized thereon. Thus, a reaction to recognize specificity among physiologically active substances is carried out, thereby detecting a substance associated with a living organism from sedimentation of gold fine particles or sequences.

In all of the above-described techniques, the surface where a physiologically active substance is immobilized is important. Surface plasmon resonance (SPR), which is most commonly used in this technical field, will be described below as an example. A commonly used measurement chip comprises a transparent substrate (e.g., glass), an evaporated metal film, and a thin film having thereon a functional group capable of immobilizing a physiologically active substance. The measurement chip immobilizes the physiologically active substance on the metal surface via the functional group. A specific binding reaction between the physiological active substance and a test substance is measured, so as to analyze an interaction between biomolecules.

On the other hand, chromatography is a technique of separating compounds (solutes) that are mixed with one another into individual compounds. Separation of individual components contained in a sample makes it easy to examine the types of various sample compounds (qualitative assay) and to measure the amounts of such sample compounds contained (quantitative assay).

Conventionally, the use of SPR has enabled only the measurement of the presence or absence of binding and the quantification of such a binding state. International Publication WO00/67028 discloses the measurement of two-dimensional SPR. However, since a solution is not supplied at an amount lower than the saturated adsorption amount on a metal film surface, a chromatogram can not be obtained.

### DISCLOSURE OF THE INVENITON

It is an object of the present invention to solve the aforementioned problem of the prior art technique. That is to say, it is an object of the present invention to provide a method for obtaining a chromatogram using the SPR analysis method. More specifically, it is an object of the present invention to provide a method for separating a mixture such as a cell extract in the SPR analysis method, and a method for conducting the quantitative and qualitative analyses of a substance based on the peak area of SPR signals, time, or the strength obtained from position, even when only a single substance is involved.

As a result of intensive studies directed towards achieving the aforementioned objects, the present inventors have found that, in a method for measuring the change in the surface plasmon resonance by using a surface plasmon resonance measurement device and exchanging a liquid in a flow channel system, the measurement can be carried out by supplying a liquid at a liquid amount such that the absolute amount of molecules adsorbed on the metal film surface is lower than the saturated adsorption amount of said molecules on said metal film surface, thereby obtaining a sharp chromatogram. The present invention has been completed based on such findings.

That is to say, the present invention provides a method for measuring the change in the surface plasmon resonance by using a surface plasmon resonance measurement device which comprises a metal film, a light source for generating a light beam, an optical system for allowing such a light beam to enter the interface of the metal film so that total reflection conditions can be obtained at the interface thereof and so that various incidence angles can be included, a flow channel system comprising a cell formed on said metal film, and a light-detecting means for detecting the state of surface plasmon resonance by measuring the intensity of the light beam totally reflected at said interface, and exchanging a liquid contained in the flow channel system; wherein the measurement is carried out by supplying a liquid at a liquid amount such that the absolute amount of molecules adsorbed on the metal film surface is lower than the saturated adsorption amount of said molecules on said metal film surface.

Preferably, the measurement is carried out under conditions wherein the concentration of molecules adsorbed on the metal film surface is lower than the value obtained by dividing the saturated adsorption amount of said molecules adsorbed per unit area of said metal film surface by the height of said flow channel.

Preferably, the surface plasmon signals are measured at three or more points located from an area upstream of said flow channel to an area downstream thereof, so as to measure the movement of adsorption of the molecules adsorbed.

Preferably, the surface plasmon signals at a part of said flow channel are continuously measured on a time axis, so as to measure the movement of adsorption of the molecules adsorbed.

### BRIEF DESCRIPTION OF THE DRAWINGS

FIG. 1 shows a chromatogram obtained when the measurement is carried out by the method of the present invention (namely, in a case where the absolute amount of molecules adsorbed on a metal film surface is lower than the saturated adsorption amount of said molecules on said metal film surface).

FIG. 2 shows a chromatogram obtained when the measurement is carried out by the method of a comparative example (namely, in a case where the absolute amount of molecules adsorbed on a metal film surface is higher than the saturated adsorption amount of said molecules on the above metal film surface).

### BEST MODE FOR CARRYING OUT THE INVENTION

The embodiments of the present invention will be described below.

The measurement method according to the present invention is a method for measuring the change in the surface plasmon resonance by using a surface plasmon resonance measurement device and exchanging a liquid contained in the flow channel system; which is characterized in that the measurement is carried out by supplying a liquid at a liquid amount such that the absolute amount of molecules adsorbed on the metal film surface is lower than the saturated adsorption amount of said molecules on said metal film surface.

Chromatography is a technique of separating compounds (solutes) that are mixed with one another into individual compounds. Separation of individual components contained in a sample makes it easy to examine the types of various sample compounds (qualitative assay) and to measure the amounts of such sample compounds contained (quantitative assay).

Molecules adsorbed on a metal surface are adsorbed thereon over time.
d θ/dt=kₐ·c·(1-θ)-k_{d}·θ . . . formula (1)
In the above formula, θ represents an adsorption rate (=adsorption amount/saturated adsorption amount); kₐ represents an adsorption rate coefficient; k_{d} represents a desorption rate; and c represents the concentration of molecules adsorbed.

In the present invention, the metal surface is measured by what is called the one-dimensional or two-dimensional plasmon resonance method. The results obtained by measuring at multiple points located from an area upstream of a flow channel to an area downstream thereof are connected, so as to obtain a chromatogram having three-dimensional information consisting of distance, time, and strength. Herein, strength relevant to a distance obtained after a certain period of time is indicated, so as to obtain a chromatogram such as that used in thin layer chromatography. In addition, by indicating measurement strength relevant to a time at a single point, it is also possible to obtain a chromatogram that represents time vs. strength. It is also possible to provide such a chromatogram in the form of three-dimensional information consisting of a distance axis, a time axis, and a strength axis.

The measurement points of surface plasmon signals in the present invention may be either continuous points or intermittent points. Such measurements points are preferably 5 or more points, and more preferably 8 or more points.

Herein, a solution containing molecules to be adsorbed flows over the surface of a metal. The solution is repeatedly adsorbed on and desorbed from a new metal surface from time to time, and thus it flows from an upstream area to a downstream area on the metal surface. A common surface plasmon signal measurement method is characterized in that a liquid is supplied at a high speed such that the number of molecules to be adsorbed existing in a flow channel is larger than the saturated adsorption amount of said molecules with reference to the surface on which they are adsorbed, so that the measurement surface can be simultaneously and uniformly subjected to adsorption and desorption reactions.

In the present invention, the number of molecules to be adsorbed existing in a flow channel is set to be smaller than the saturated adsorption amount of the above molecules with reference to the surface on which they are adsorbed, so that the molecules can repeatedly be adsorbed on and desorbed from the metal surface, thereby generating a chromatogram.

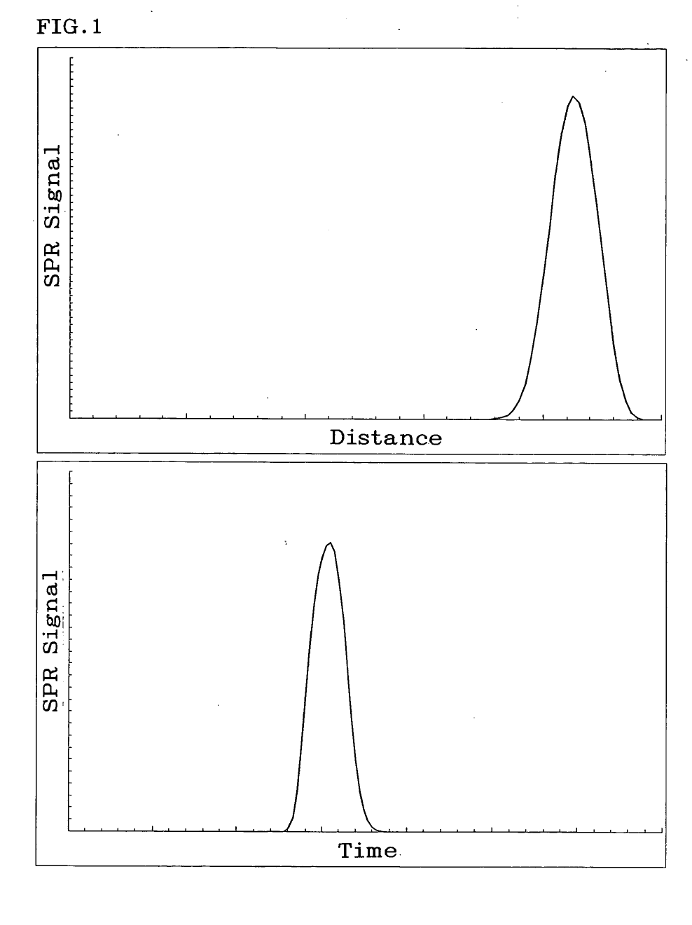

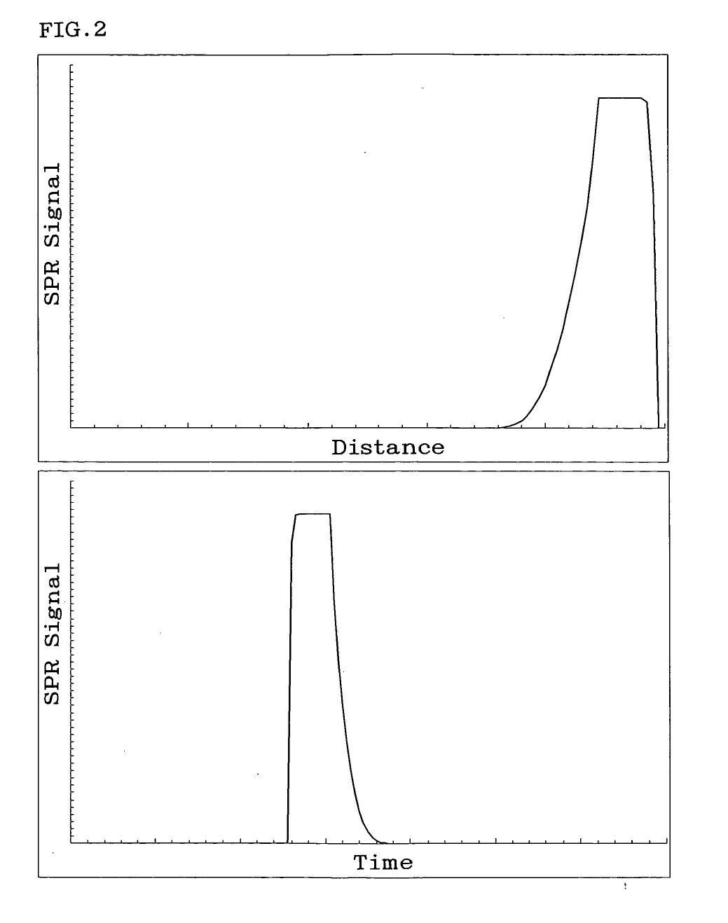

The liquid supplying speed is preferably slower than the linear speed for moving over the distance between measurement points for one or more seconds. When the concentration of molecules to be adsorbed is lower than the saturated adsorption amount, and when the concentration of molecules to be adsorbed on the metal film surface is lower than the value obtained by dividing the saturated adsorption amount of the molecules adsorbed per unit area of the metal film surface by the height of the above flow channel, a sharp chromatogram can be obtained as shown in FIG. 1. In contrast, when the concentration of molecules to be adsorbed is higher than the saturated adsorption amount, a sharp chromatogram can not be obtained as shown in FIG. 2.

The length of the metal surface in the flow channel in the present invention is preferably between 1 mm and 100 m, and more preferably between 5 mm and 10 m.

The area of the metal surface in the flow channel in the present invention is preferably between 0.1 mm² and 100 cm², and more preferably between 10 mm² and 50 cm².

The surface plasmon resonance phenomenon occurs due to the fact that the intensity of monochromatic light reflected from the border between an optically transparent substance such as glass and a metal thin film layer depends on the refractive index of a sample located on the outgoing side of the metal. Accordingly, the sample can be analyzed by measuring the intensity of reflected monochromatic light. The surface plasmon resonance measurement device used in the present invention will be described below.

The surface plasmon resonance measurement device is a device for analyzing the properties of a substance to be measured using a phenomenon whereby a surface plasmon is excited with a lightwave. The surface plasmon resonance measurement device used in the present invention comprises a metal film, a light source for generating a light beam, an optical system for allowing such a light beam to enter the interface of the metal film so that total reflection conditions can be obtained at the interface thereof and so that various incidence angles can be included, a flow channel system comprising a cell formed on said metal film, and a light-detecting means for detecting the state of surface plasmon resonance by measuring the intensity of the light beam totally reflected at said interface.

A surface plasmon resonance measurement device can be used, which comprises a dielectric block, a metal film formed on a face of the dielectric block, a light source for generating a light beam, an optical system for allowing the above light beam to enter the above dielectric block such that total reflection conditions can be obtained at the interface between the dielectric block and the metal film and that components at various incident angles can be contained, and a light-detecting means for detecting the state of surface plasmon resonance by measuring the intensity of the light beam totally reflected at the above interface.

Moreover, as stated above, the dielectric block is formed as one block comprising the entity of the entrance face and exit face of the above light beam and a face on which the above metal film is formed, and the metal film is integrated with this dielectric block.

In the present invention, more specifically, a surface plasmon resonance measurement device shown in FIGS. 1 to 32 of Japanese Patent Laid-Open No. 2001-330560, and a surface plasmon resonance measurement device shown in FIGS. 1 to 15 of Japanese Patent Laid-Open No. 2002-296177, can be preferably used. All of the contents as disclosed in Japanese Patent Laid-Open Nos. 2001-330560 and 2002-296177 cited in the present specification are incorporated herein by reference as a part of the disclosure of this specification.

For example, the surface plasmon resonance measurement device described in Japanese Patent Laid-Open No. 2001-330560 is characterized in that it comprises: a dielectric block; a thin metal film formed on a face of the dielectric block; multiple measurement units comprising a sample-retaining mechanism for retaining a sample on the surface of the thin film; a supporting medium for supporting the multiple measurement units; a light source for generating a light beam; an optical system for allowing the above light beam to enter the dielectric block at various angles so that total reflection conditions can be obtained at the interface between the dielectric block and the metal film; a light-detecting means for measuring the intensity of the light beam totally reflected at the above interface and detecting the state of attenuated total reflection caused by surface plasmon resonance; and a driving means for making the above supporting medium, the above optical system and the above light-detecting means move relative to one another, and successively placing each of the above multiple measurement units in a certain position appropriate to the above optical system and the above light-detecting means, so that the above total reflection conditions and various incident angles can be obtained with respect to each dielectric block of the above multiple measurement units.

It is to be noted that in the above measurement device, the above optical system and light-detecting means are kept in a resting state and the above driving means makes the above supporting medium move.

In such a case, the above supporting medium is desirably a turntable for supporting the above multiple measurement units on a circle centered on a rotation axis, and the above driving means is desirably a means for intermittently rotating this turntable. In this case, a medium for supporting the above multiple measurement units that are linearly arranged in a line may be used as the above supporting medium, and a means that makes such a supporting medium move linearly in an intermittent fashion in the direction in which the above multiple measurement units are arranged may be applied as the above driving means.

Otherwise, on the contrary, it may also be possible that the above supporting medium be retained in a resting state and that the above driving means makes the above optical system and light-detecting means move.

In such a case, the above supporting medium is desirably a medium for supporting the above multiple measurement units on a circle, and the above driving means is desirably a means for intermittently rotating the above optical system and light-detecting means along the multiple measurement units supported by the above supporting medium. In this case, a medium for supporting the above multiple measurement units that are linearly arranged in a line may be used as the above supporting medium, and a means that makes the above optical system and light-detecting means move linearly in an intermittent fashion along the multiple measurement units supported by the above supporting medium may be applied as the above driving means.

Otherwise, when the above driving means has a rolling bearing that supports a rotation axis, the driving means is desirably configured such that after the rotation axis has been rotated to a certain direction and a series of measurements for the above multiple measurement units has been terminated, the above rotation axis is equivalently rotated to the opposite direction, and then it is rotated again to the same above direction for the next series of measurements.

In addition, the above-described measurement device is desirably configured such that the above multiple measurement units are connected in a line with a connecting member so as to constitute a unit connected body and that the above supporting medium supports the unit connected body.

Moreover, in the above-described measurement device, it is desirable to establish a means for automatically feeding a given sample to each sample-retaining mechanism of the multiple measurement units supported by the above supporting medium.

Furthermore, in the above-described measurement device, it is desirable that the dielectric block of the above measurement unit be immobilized to the above supporting medium, that a thin film layer and a sample-retaining mechanism of the measurement unit be unified so as to constitute a measurement chip, and that the measurement chip be formed such that it is exchangeable with respect to the above dielectric block.

When such a measurement chip is applied, it is desirable to establish a cassette for accommodating a multiple number of the measurement chips and a chip-supplying means for successively taking a measurement chip out of the cassette and supplying it in a state in which it is connected to the above dielectric block.

Otherwise, it may also be possible to unify the dielectric block of the measurement unit, the thin film layer and the sample-retaining mechanism, so as to constitute a measurement chip, and it may also be possible for this measurement chip to be formed such that it is exchangeable with respect to the above supporting medium.

When a measurement chip has such a structure, it is desirable to establish a cassette for accommodating a multiple number of measurement chips and a chip-supplying means for successively taking a measurement chip out of the cassette and supplying it in a state in which it is supported by the supporting medium.

The above optical system is desirably configured such that it makes a light beam enter the dielectric block in a state of convergent light or divergent light. Moreover, the above light-detecting means is desirably configured such that it detects the position of a dark line generated due to attenuated total reflection, which exists in the totally reflected light beam.

Furthermore, the above optical system is desirably configured such that it makes a light beam enter the above interface in a defocused state. In this case, the beam diameter of the light beam at the above interface in a direction wherein the above supporting medium moves is desirably ten times or greater the mechanical positioning precision of the above supporting medium.

Still further, the above-described measurement device is desirably configured such that the measurement unit is supported on the upper side of the above supporting medium, such that the above light source is placed so as to project the above light beam from a position above the above supporting medium to downwards, and such that the above optical system comprises a reflecting member for reflecting upwards the above light beam projected to downwards as described above and making it proceed towards the above interface.

Still further, the above-described measurement device is desirably configured such that the above measurement unit is supported on the upper side of the above supporting medium, such that the above optical system is constituted so as to make the above light beam enter the above interface from the downside thereof, and such that the above light-detecting means is placed in a position above the above supporting medium with a light-detecting plane thereof facing downwards, as well as comprising a reflecting member for reflecting upwards the totally reflected light beam at the above interface and making it proceed towards the above light-detecting means.

What is more, the above-described measurement device desirably comprises a temperature-controlling means for maintaining the temperature of the above measurement unit before and/or after being supported by the above supporting medium at a predetermined temperature.

Moreover, the above-described measurement device desirably comprises a means for stirring the sample stored in the sample-retaining mechanism of the measurement unit supported by the above supporting medium before detecting the state of attenuated total reflection as mentioned above.

Furthermore, in the above-described measurement device, it is desirable to establish in at least one of the multiple measurement units supported by the above supporting medium a standard solution-supplying means for supplying a standard solution having optical properties associated with the optical properties of the above sample, as well as a correcting means for correcting data regarding the above attenuated total reflection state of the sample based on the data regarding the above attenuated total reflection state of the above standard solution.

In such a case, if the sample is obtained by dissolving a test substance in a solvent, it is desirable that the above standard solution-supplying means be a means for supplying the above solvent as a standard solution.

Still further, the above measurement device desirably comprises: a mark for indicating individual recognition information; a reading means for reading the above mark from the measurement unit used in measurement; an inputting means for inputting sample information regarding the sample supplied to the measurement unit; a displaying means for displaying measurement results; and a controlling means connected to the above displaying means, inputting means and reading means, which stores the above individual recognition information and sample information of each measurement unit while associating them with each other, as well as making the above displaying means display the measurement results of the sample retained in a certain measurement unit while associating them with the above individual recognition information and sample information of each measurement unit.

When a substance interacting with a physiologically active substance is detected or measured using the above-described measurement device, a state of attenuated total reflection is detected in a sample contained in one of the above measurement units, and thereafter, the above supporting medium, optical system and light-detecting means are moved relative to one another, so that a state of attenuated total reflection is detected in a sample contained in another measurement unit. Thereafter, the above supporting medium, optical system and light-detecting means are again moved relative to one another, so that a state of attenuated total reflection is detected again the sample contained in the above one measurement unit, thereby completing the measurement.

The measurement chip used in the present invention is used for the surface plasmon resonance measurement device having a structure described herein, and comprises a dielectric block and a metal film formed on a face of the dielectric block, in which the dielectric block is formed as one block comprising the entirety of the entrance face and exit face of the light beam and a face on which the above metal film is formed, the above metal film is integrated with the above dielectric block.

A metal constituting the metal film is not particularly limited, as long as surface plasmon resonance is generated. Examples of a preferred metal may include free-electron metals such as gold, silver, copper, aluminum or platinum. Of these, gold is particularly preferable. These metals can be used singly or in combination. Moreover, considering adherability to the above substrate, an interstitial layer consisting of chrome or the like may be provided between the substrate and a metal layer.

The film thickness of a metal film is not limited. When the metal film is used for a surface plasmon resonance biosensor, the thickness is preferably between 0.1 nm and 500 nm, and particularly preferably between 1 nm and 200 nm. If the thickness exceeds 500 nm, the surface plasmon phenomenon of a medium cannot be sufficiently detected. Moreover, when an interstitial layer consisting of chrome or the like is provided, the thickness of the interstitial layer is preferably between 0.1 nm and 10 nm.

Formation of a metal film may be carried out by common methods, and examples of such a method may include sputtering method, evaporation method, ion plating method, electroplating method, and nonelectrolytic plating method.

A metal film is preferably placed on a substrate. The description “placed on a substrate” is used herein to mean a case where a metal film is placed on a substrate such that it directly comes into contact with the substrate, as well as a case where a metal film is placed via another layer without directly coming into contact with the substrate. When a substrate used in the present invention is used for a surface plasmon resonance biosensor, examples of such a substrate may include, generally, optical glasses such as BK7, and synthetic resins. More specifically, materials transparent to laser beams, such as polymethyl methacrylate, polyethylene terephthalate, polycarbonate or a cycloolefm polymer, can be used. For such a substrate, materials that are not anisotropic with regard to polarized light and having excellent workability are preferably used.

Preferably, the metal film has a functional group capable of immobilizing a physiologically active substance (namely, a ligand to a test substance) on the outermost surface of the substrate. The term “the outermost surface of the substrate” is used to mean “the surface, which is farthest from the substrate”.

Examples of a preferred functional group may include —OH, —SH, —COOH, —NR¹R² (wherein each of R¹ and R² independently represents a hydrogen atom or lower alkyl group), —CHO, —NR³NR¹R² (wherein each of R¹, R² and R³ independently represents a hydrogen atom or lower alkyl group), —NCO, —NCS, an epoxy group, and a vinyl group. The number of carbon atoms contained in the lower alkyl group is not particularly limited herein. However, it is generally about C1 to C10, and preferably C1 to C6.

Examples of the method of introducing such a functional group include a method which involves applying a polymer containing a precursor of such a functional group on a metal surface or metal film, and then generating the functional group from the precursor located on the outermost surface by chemical treatment.

In the measurement chip obtained as mentioned above, a physiologically active substance is covalently bound thereto via the above functional group, so that the physiologically active substance can be immobilized on the metal film.

A physiologically active substance immobilized on the surface for the measurment chip of the present invention is not particularly limited, as long as it interacts with a measurement target. Examples of such a substance may include an immune protein, an enzyme, a microorganism, nucleic acid, a low molecular weight organic compound, a nonimmune protein, an immunoglobulin-binding protein, a sugar-binding protein, a sugar chain recognizing sugar, fatty acid or fatty acid ester, and polypeptide or oligopeptide having a ligand-binding ability.

Examples of an immune protein may include an antibody whose antigen is a measurement target, and a hapten. Examples of such an antibody may include various immunoglobulins such as IgG; IgM, IgA, IgE or IgD. More specifically, when a measurement target is human serum albumin, an anti-human serum albumin antibody can be used as an antibody. When an antigen is an agricultural chemical, pesticide, methicillin-resistant Staphylococcus aureus, antibiotic, narcotic drug, cocaine, heroin, crack or the like, there can be used, for example, an anti-atrazine antibody, anti-kanamycin antibody, anti-metamphetamine antibody, or antibodies against O antigens 26, 86, 55, 111 and 157 among enteropathogenic Escherichia coli.

An enzyme used as a physiologically active substance herein is not particularly limited, as long as it exhibits an activity to a measurement target or substance metabolized from the measurement target. Various enzymes such as oxidoreductase, hydrolase, isomerase, lyase or synthetase can be used. More specifically, when a measurement target is glucose, glucose oxidase is used, and when a measurement target is cholesterol, cholesterol oxidase is used. Moreover, when a measurement target is an agricultural chemical, pesticide, methicillin-resistant Staphylococcus aureus, antibiotic, narcotic drug, cocaine, heroin, crack or the like, enzymes such as acetylcholine esterase, catecholamine esterase, noradrenalin esterase or dopamine esterase, which show a specific reaction with a substance metabolized from the above measurement target, can be used.

A microorganism used as a physiologically active substance herein is not particularly limited, and various microorganisms such as Escherichia coli can be used.

As nucleic acid, those complementarily hybridizing with nucleic acid as a measurement target can be used. Either DNA (including cDNA) or RNA can be used as nucleic acid. The type of DNA is not particularly limited, and any of native DNA, recombinant DNA produced by gene recombination and chemically synthesized DNA may be used.

As a low molecular weight organic compound, any given compound that can be synthesized by a common method of synthesizing an organic compound can be used.

A nonimmune protein used herein is not particularly limited, and examples of such a nonimmune protein may include avidin (streptoavidin), biotin, and a receptor.

Examples of an immunoglobulin-binding protein used herein may include protein A, protein G, and a rheumatoid factor (RF).

As a sugar-binding protein, for example, lectin is used.

Examples of fatty acid or fatty acid ester may include stearic acid, arachidic acid, behenic acid, ethyl stearate, ethyl arachidate, and ethyl behenate.

When a physiologically active substance is a protein such as an antibody or enzyme, or nucleic acid, an amino group, thiol group or the like of the physiologically active substance is covalently bound to a functional group located on a metal surface, so that the physiologically active substance can be immobilized on the metal surface.

A measurement chip to which a physiologically active substance is immobilized as described above can be used to detect and/or measure a substance which interacts with the physiologically active substance.

The present invention is described in detail by the following examples, but the scope of the present invention is not limited by these examples.

### EXAMPLES

The following experiment can be conducted by measuring SPR signals at multiple points using an SPRimager manufactured by GWC.

(1) Production of measurement chip

An optically polished glass plate (BSC7 manufactured by HOYA) with a thickness of 0.3 mm is coated with 50 nm of gold used as a metal film via evaporation. The thus obtained glass plate coated with a metal film is treated with a Model-208 UV-ozone cleaning system (TECHNOVISION INC.) for 30 minutes. Thereafter, the resultant plate is spin-coated with a solution of polystyrene in 2-butanone, resulting in a thickness of 20 nm.

(2) Evaluation of bovine serum albumin (BSA) solution

The measurement chip produced in (1) above is placed in a surface plasmon measurement device. A sucrose solution, the refractive index of which has previously been known, is supplied, so that a calibration curve regarding the output of the surface plasmon device to the refractive index is produced. Herein, a change in the refractive index around the metal surface linearly correlates with the adsorption amount of BSA. The value outputted from the surface plasmon device, which was calibrated to the refractive index, using this calibration curve, is defined as a surface plasmon signal.

The inside of a flow channel system is filled with buffer 2 (10 mM HEPES, 150 mM NaCI). BSA solution (obtained by dissolving BSA in buffer 2) is supplied into the flow channel system at an amount of 1/100 of the flow channel volume of the metal surface, and the solution is continuously substituted with buffer 2. When the concentration of the BSA solution during this step is set at 1/10 of the value obtained by dividing the saturated adsorption amount on the metal surface by the height of the flow channel, the same chromatogram as that shown in FIG. 1 is obtained. When such a concentration is set at 10 times higher than the above value, the same chromatogram as that shown in FIG. 2 is obtained.

### EFFECTS OF THE INVENTION

According to the present invention, it has become possible to obtain a chromatogram in the SPR analysis method. Using the method of the present invention, it becomes possible to separate a mixture such as a cell extract, or to conduct quantitative and qualitative analyses of a substance based on the peak area of SPR signals, time, or the strength obtained from position, even when only a single substance is involved, in the SPR analysis method.

1. A method for measuring the change in the surface plasmon resonance by using a surface plasmon resonance measurement device which comprises a metal film, a light source for generating a light beam, an optical system for allowing such a light beam to enter the interface of the metal film so that total reflection conditions can be obtained at the interface thereof and so that various incidence angles can be included, a flow channel system comprising a cell formed on said metal film, and a light-detecting means for detecting the state of surface plasmon resonance by measuring the intensity of the light beam totally reflected at said interface, and exchanging a liquid contained in the flow channel system; wherein the measurement is carried out by supplying a liquid at a liquid amount such that the absolute amount of molecules adsorbed on the metal film surface is lower than the saturated adsorption amount of said molecules on said metal film surface.

2. The measurement method according to claim 1, wherein the measurement is carried out under conditions wherein the concentration of molecules adsorbed on the metal film surface is lower than the value obtained by dividing the saturated adsorption amount of said molecules adsorbed per unit area of said metal film surface by the height of said flow channel.

3. The measurement method according to claim 1, wherein the surface plasmon signals are measured at three or more points located from an area upstream of said flow channel to an area downstream thereof, so as to measure the movement of adsorption of the molecules adsorbed.

4. The measurement method according to claim 1, wherein the surface plasmon signals at a part of said flow channel are continuously measured on a time axis, so as to measure the movement of adsorption of the molecules adsorbed.
